(19) United States
(12) Patent Application Publication
(10) Pub. No.: US 2026/0326629 A1
(43) Pub. Date: Oct. 22, 2026

(54) SEAT MOVING APPARATUS FOR VEHICLE

(71) Applicant: Hyundai Transys Inc., Seosan-si (KR)

(72) Inventors: CHEON KIM, Hwaseong-si (KR); KYEONG HO SEO, Hwaseong-si (KR); HEOUNG SU LIM, Hwaseong-si (KR); JUNGHYUN HAN, Hwaseong-si (KR); SEONGJUN HWANG, Hwaseong-si (KR)

(21) Appl. No.: 19/566,268

(22) Filed: Mar. 13, 2026

(30) Foreign Application Priority Data
Apr. 22, 2025 (KR) 10-2025-0052555

(51) Int. Cl. B60N 2/07

(52) U.S. Cl. CPC B60N 2/0722

(57) ABSTRACT

A seat moving apparatus for a vehicle includes a winding device provided on an upper rail and having one surface on which a winding portion is provided, a tension member wound around the winding portion so that two opposite ends of the tension member, which are directed in opposite directions, are connected to two opposite longitudinal sides of a lower rail, and an elastic member accommodated in the winding portion and configured to elastically support the winding device.

### CROSS-REFERENCE TO RELATED APPLICATIONS

This application claims priority to and the benefit of Korean Patent Application No. 10-2025-0052555 filed in the Korean Intellectual Property Office on Apr. 22, 2025, the entire contents of which are incorporated herein by reference.

### TECHNICAL FIELD

The present invention relates to a seat moving apparatus for a vehicle.

### BACKGROUND

In general, a seat rail may be mounted in a vehicle interior. The seat rail may include a lower rail and an upper rail. The lower rail may be mounted on a floor panel in the vehicle interior. When a force is applied to a seat, an upper rail connected to the seat may slide along the lower rail in a state in which the upper rail is inserted into the lower rail.

Recently, in preparation for autonomous driving of electric vehicles, multipurpose seats, such as a 360-degree rotating seat with a long stroke, have been developed.

Methods of operating power long rail devices, which are applied to seats of electric vehicles, may be classified into a rack-pinion method and a lead-screw method. There is a problem in that the rack-pinion method and the lead-screw method require a large number of components that are assembled by various complicated structures.

In order to solve the problems of the rack-pinion method and the lead-screw method, a seat moving apparatus for a vehicle, which uses a wire-pulley method, has been developed.

However, the seat moving apparatus for a vehicle using the wire-pulley method has a structure in which two wires are mounted on a pulley, and a seat is moved by operations of the two wires. Because a large number of components, such as a brake drum, a clutch module, an input device, and a restoring spring, are required to maintain tension of the two wires, there is a drawback in that a large amount of costs are inevitably incurred, and there is a disadvantage in managing quality of components during an assembling process.

### Document of Related Art

### Patent Document

(Patent Document 1) Chinese Patent Application Laid-Open No. 116353437 (published on Jun. 30, 2023)

### SUMMARY

The present disclosure has been made in an effort to solve the above-mentioned problem, and an object of the present disclosure is to provide a seat moving apparatus for a vehicle, the seat moving apparatus being capable of moving a seat while maintaining tension of a single tension member.

In order to achieve the above-mentioned object, the present disclosure provides a seat moving apparatus for a vehicle. The seat moving apparatus may include: a winding device configured to be disposed on an upper rail and having one surface, a winding portion extending from the one surface; a tension member wound around the winding portion such that two opposite ends of the tension member, which are directed in opposite directions, are configured to be connected to two opposite sides of a lower rail, respectively, along a longitudinal direction of the lower rail; and an elastic member disposed in the winding portion and configured to elastically support the winding device.

In addition, the tension member may include: a support portion positioned in the winding portion; one-side wound portion extending from one end of the support portion and wound around a proximal portion of an outer-diameter portion of the winding portion, the proximal portion being positioned adjacent to the one surface of the winding device; one-side extension portion extending from the one-side wound portion and having an end directed toward one side of the upper rail along a longitudinal direction of the upper rail; another-side wound portion extending from another end of the support portion and wound around a distal portion of the outer-diameter portion of the winding portion, the distal portion being opposite to the proximal portion; and another-side extension portion extending from the another-side wound portion and having an end directed toward another side of the upper rail along the longitudinal direction of the upper rail.

In addition, the winding portion may include: a first through-hole defined in the proximal portion of the outer-diameter portion at a first side thereof; a second through-hole connected to the first through-hole and defined in the distal portion of the outer-diameter portion, the first through-hole and the second through-hole defining a stepped portion together; a third through-hole defined in the proximal portion of the outer-diameter portion at a second side thereof; a fourth through-hole connected to the third through-hole and defined in the distal portion of the outer-diameter portion, the third through-hole and the fourth through-hole defining a stepped portion together; and a fifth through-hole defined in a portion of the outer-diameter portion between the first through-hole and the third through-hole.

In addition, the one-side wound portion may penetrate the first through-hole and be wound inside the outer-diameter portion of the winding portion, and the another-side wound portion may penetrate the fourth through-hole and be wound outside the outer-diameter portion of the winding portion.

In addition, the elastic member may include one-side assembled portion, and the one-side assembled portion may penetrate the fifth through-hole and is wound around the outer-diameter portion of the winding portion, and a hook portion positioned at an end of the one-side assembled portion may penetrate the fourth through-hole and may be inserted into and caught by the winding portion.

In addition, the distal portion may define an opening of the winding portion at a distal end thereof, and a cover may be coupled to the distal end of the winding portion to span the opening to retain the support portion and the elastic member in the winding portion.

In addition, the cover may include: a protrusion portion extending from one surface of the cover in a direction toward the winding portion; and a fitting hole defined in the protrusion portion.

In addition, the elastic member may include a catching portion at another end of the elastic member, and the catching portion may be inserted into and caught by the fitting hole.

In addition, the elastic member may be supported by a contact portion disposed inside the winding portion.

In addition, the contact portion may surround at least a part of an outer side of the elastic member.

In addition, the winding device and the cover may be disposed in a casing, and the casing may be disposed on the upper rail.

In addition, a first seating portion, which is disposed on another surface of the winding device opposite to the one surface of the winding device, and a second seating portion, which is disposed on another surface of the cover opposite to the one surface of the cover, may be seated in a support groove of a support frame disposed in the casing, the support frame being disposed on the upper rail.

In addition, the end of the one-side extension portion may pass through one-side guide hole of one-side bracket disposed at one side of an upper portion of the upper rail and be connected to one side of the lower rail, and the end of the another-side extension portion may pass through another-side guide hole of another-side bracket disposed at another side of the upper portion of the upper rail and be connected to another side of the lower rail.

In addition, the elastic member may be a spiral spring.

In addition, the tension member may be configured as a band-shaped wire capable of being wound around an outer-diameter portion of the winding portion.

In addition, the contact portion may be a wall extending from the one surface of the winding device and surrounding at least a part of an outer side of the elastic member.

In addition, the support portion may be wound around the wall in the winding portion, and the support portion and the elastic member may be separated by the wall in the winding portion.

In addition, the stepped portion defined by the first through-hole and the second through-hole may define a first shoulder facing toward the one surface of the winding device, and the stepped portion defined by the third through-hole and the fourth through-hole may define a second shoulder facing away from the one surface of the winding device.

According to the present disclosure, the seat moving apparatus for a vehicle may move the seat while maintaining the tension of the single tension member, thereby reducing costs in comparison with a wire-pulley driving system in the related art.

In addition, according to the present disclosure, the number of components may be minimized, and the components may be conveniently assembled, thereby providing an advantage in managing the quality of the components.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating a state in which a seat moving apparatus for a vehicle according to an exemplary embodiment of the present disclosure is mounted on a seat rail.

FIG. 2 is a view illustrating a state in which a tension member and an elastic member are assembled to a winding device according to the exemplary embodiment of the present disclosure.

FIG. 3 is a view illustrating the winding device according to the exemplary embodiment of the present disclosure.

FIG. 4 is a view illustrating a state in which the tension member is assembled to the winding device according to the exemplary embodiment of the present disclosure.

FIG. 5 is a view illustrating a state in which the elastic member is assembled to the winding device according to the exemplary embodiment of the present disclosure.

FIG. 6 is a view illustrating a state in which a catching portion of the elastic member is coupled to a fitting hole of a protrusion portion provided on one surface of a cover according to the exemplary embodiment of the present disclosure.

FIG. 7 is an enlarged view illustrating the seat moving apparatus for a vehicle according to the exemplary embodiment of the present disclosure.

FIG. 8 is a front view illustrating the seat moving apparatus for a vehicle according to the exemplary embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, exemplary embodiments of the present disclosure will be described in detail with reference to the accompanying drawings. First, in assigning reference numerals to constituent elements of the respective drawings, it should be noted that the same constituent elements will be designated by the same reference numerals, if possible, even though the constituent elements are illustrated in different drawings. In addition, in the description of the present disclosure, the specific descriptions of publicly known related configurations or functions will be omitted when it is determined that the specific descriptions may obscure the subject matter of the present disclosure. Further, the exemplary embodiments of the present disclosure will be described below, but the technical spirit of the present disclosure is not limited thereto and may, of course, be modified and variously carried out by those skilled in the art.

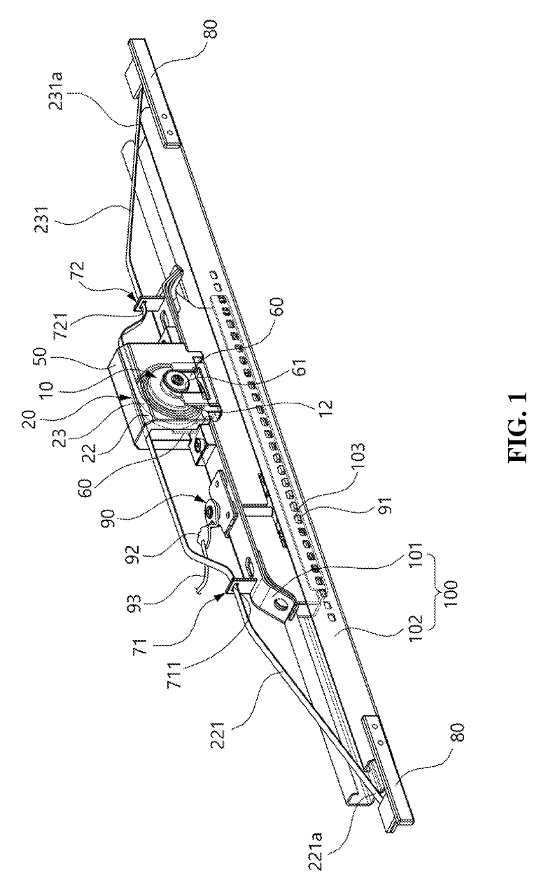

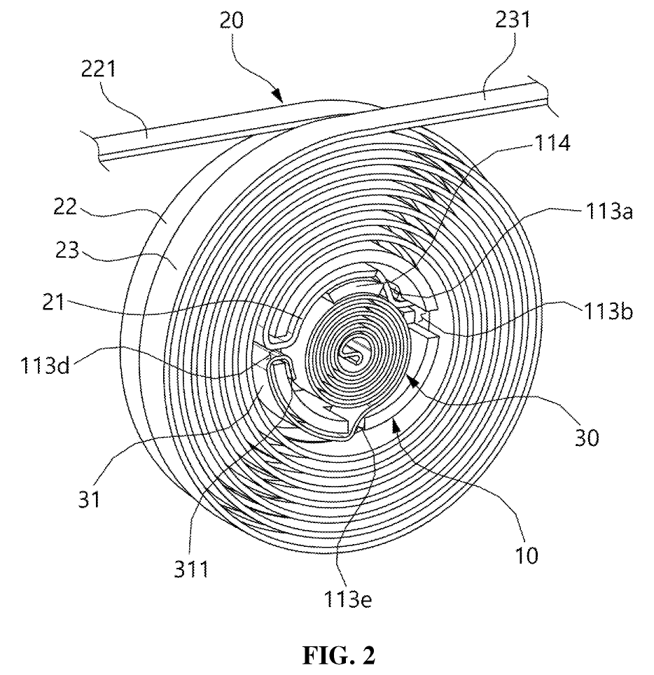

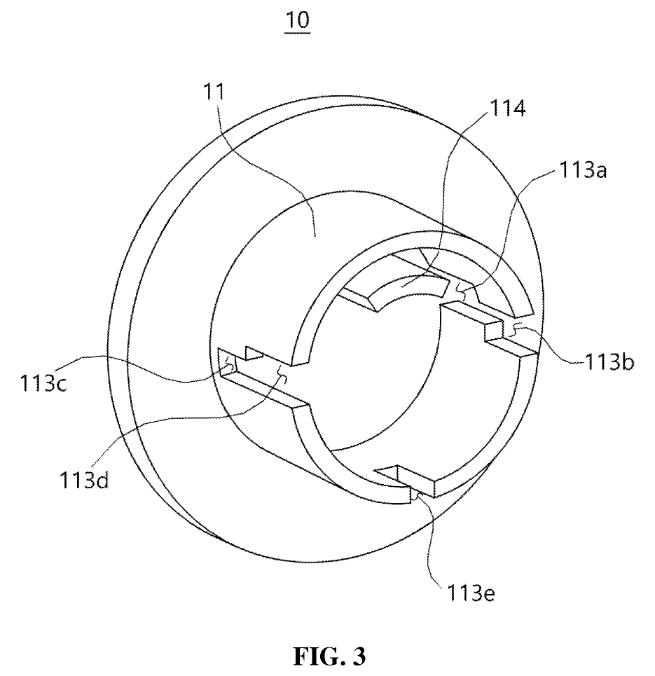

FIG. 1 is a view illustrating a state in which a seat moving apparatus for a vehicle according to an exemplary embodiment of the present disclosure is mounted on a seat rail. FIG. 2 is a view illustrating a state in which a tension member and an elastic member are assembled to a winding device according to the exemplary embodiment of the present disclosure. FIG. 3 is a view illustrating the winding device according to the exemplary embodiment of the present disclosure.

As illustrated in FIGS. 1 - 3, a seat moving apparatus for a vehicle according to the present disclosure may include a winding device 10 provided on an upper rail 101, a tension member 20 wound around the winding device 10, and an elastic member 30 configured to elastically support the winding device 10.

The winding device 10 may include a winding portion 11, a plurality of through-holes provided in an outer-diameter portion of the winding portion 11, and a contact portion 114 provided inside the winding portion 11.

The winding portion 11 may protrude in a direction from one surface of the winding device 10 toward a cover 40. One side wound portion 22 and the other side wound portion 23 of the tension member 20 may be wound inside and outside the outer-diameter portion of the winding portion 11.

The winding portion 11 may include a first through-hole 113a, a second through-hole 113b, a third through-hole 113c, a fourth through-hole 113d, and a fifth through-hole 113e.

The first through-hole 113a may be formed through one side of the outer-diameter portion of the winding portion 11. The first through-hole 113a may be formed through an inner or proximal portion of one side of the outer-diameter portion. The proximal portion may be adjacent to the one surface of the winding device 10.

The second through-hole 113b may be connected to the first through-hole 113a. The second through-hole 113b may form a stepped portion together with the first through-hole 113a. The second through-hole 113b may be formed through an outer or distal portion of the one side of the outer-diameter portion of the winding portion 11. The distal portion may be opposite the proximal portion of the winding portion 11.

The third through-hole 113c may be formed through the other side of the outer-diameter portion of the winding portion 11. The third through-hole 113c may be formed through an inner or proximal portion of the other side of the outer-diameter portion of the winding portion 11. The proximal portion may be adjacent to the one surface of the winding device 10.

The fourth through-hole 113d may be connected to the third through-hole 113c. The fourth through-hole 113d may be configured to form a stepped portion together with the third through-hole 113c. The fourth through-hole 113d may be formed through an outer or distal portion of the other side of the outer-diameter portion of the winding portion 11. The distal portion may be opposite the proximal portion of the winding portion 11.

The fifth through-hole 113e may be formed through a portion of the outer-diameter portion of the winding portion 11 between the first through-hole 113a and the third through-hole 113c.

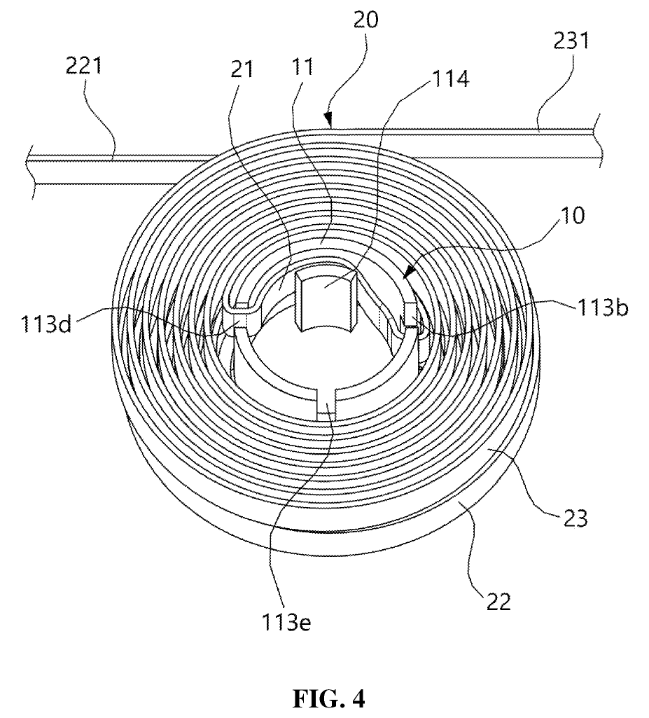

FIG. 4 is a view illustrating a state in which the tension member is assembled to the winding device according to the exemplary embodiment of the present disclosure.

As illustrated in FIG. 4, the tension member 20 may be configured as a band-shaped wire that may be wound around the outer-diameter portion of the winding portion 11. The tension member 20 may be configured as a band-shaped wire and securely wound around the outer-diameter portion of the winding portion 11.

The tension member 20 may include a support portion 21, one side wound portion 22, one side extension portion 221, the other side wound portion 23, and the other side extension portion 231.

The support portion 21 may be positioned in the winding portion 11. One side wound portion 22 may extend from one side of the support portion 21.

One side wound portion 22 may be exposed through the first through-hole 113a and wound around the inner portion of the outer-diameter portion of the winding portion 11.

The other side wound portion 23 may be exposed through the fourth through-hole 113d and wound around the outer portion of the outer-diameter portion of the winding portion 11.

One side extension portion 221 may extend from one side wound portion 22. An end 221a of one side extension portion 221 may be connected to one side of a lower rail 102.

The other side extension portion 231 may extend from the other side wound portion 23. An end 231a of the other side extension portion 231 may be connected to the other side of the lower rail 102.

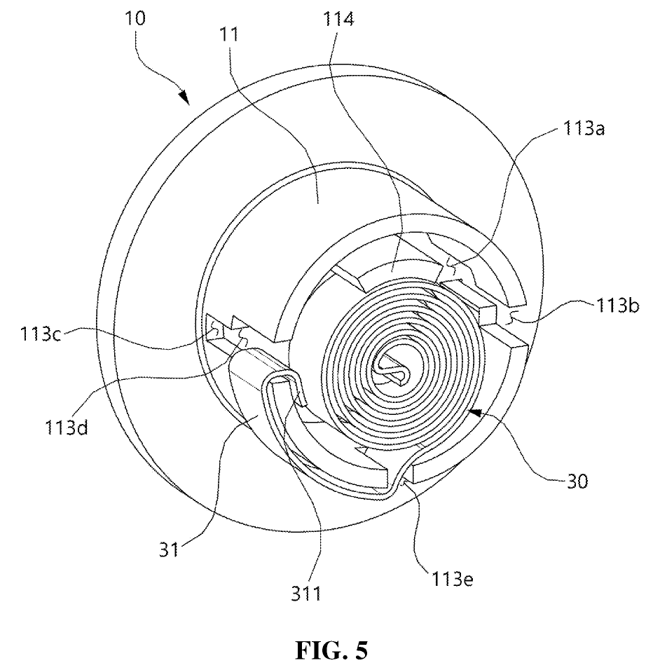

FIG. 5 is a view illustrating a state in which the elastic member is assembled to the winding device according to the exemplary embodiment of the present disclosure.

As illustrated in FIG. 5, the elastic member 30 may be a spiral spring.

The elastic member 30 may include one side assembled portion 31 and a hook portion 311. One side assembled portion 31 may pass through the fifth through-hole 113e and be wound around the outer-diameter portion of the winding portion 11. The hook portion 311 may be provided at an end of one side assembled portion 31. The hook portion 311 may be inserted into the winding portion 11 through the fourth through-hole 113d and assembled to be caught by the inside of the winding portion 11.

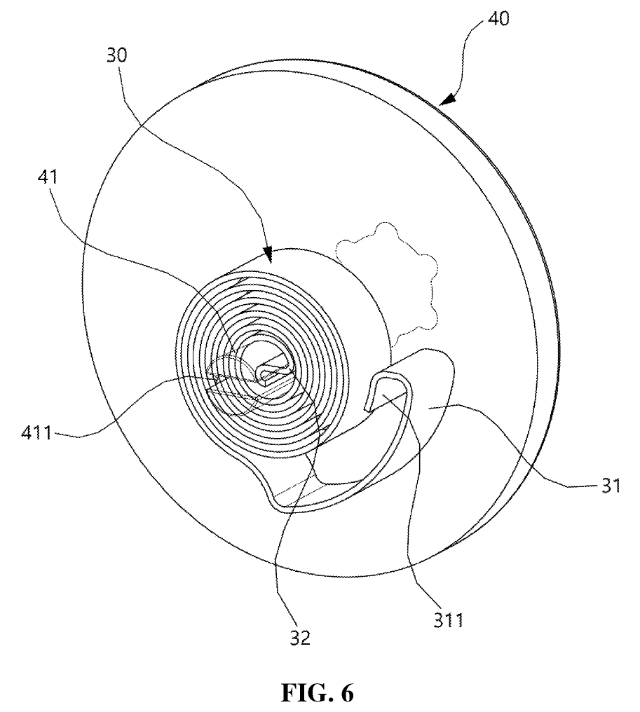

FIG. 6 is a view illustrating a state in which a catching portion of the elastic member is coupled to a fitting hole of a protrusion portion provided on one surface of the cover according to the exemplary embodiment of the present disclosure.

As illustrated in FIGS. 2, 5, and 6, the cover 40 may be coupled to one open side of the winding portion 11 in a state in which the support portion 21 and the elastic member 30 are assembled in the winding portion 11. The cover 40 may be coupled to the winding portion 11 by a coupling member, such as a bolt.

The cover 40 may include a protrusion portion 41 and a fitting hole 411. The protrusion portion 41 may extend in a direction from one surface of the cover 40 toward the winding portion 11. The fitting hole 411 may be provided in the protrusion portion 41. A catching portion 32 provided at the other end of the elastic member 30 may be assembled to be inserted into and caught by the fitting hole 411.

The elastic member 30 may be supported by the contact portion 114 of the winding portion 11 in the state in which the elastic member 30 is inserted into the winding portion 11. The contact portion 114 may surround at least a part of an outer side of the elastic member 30.

As described above, the hook portion 311 of the elastic member 30 is inserted into and caught by the winding portion 11 through the fourth through-hole 113d, the catching portion 32 is assembled to be fitted into and caught by the fitting hole 411 of the cover 40, and the elastic member 30 is supported by the contact portion 114, such that the elastic member 30 may be in a securely assembled state,

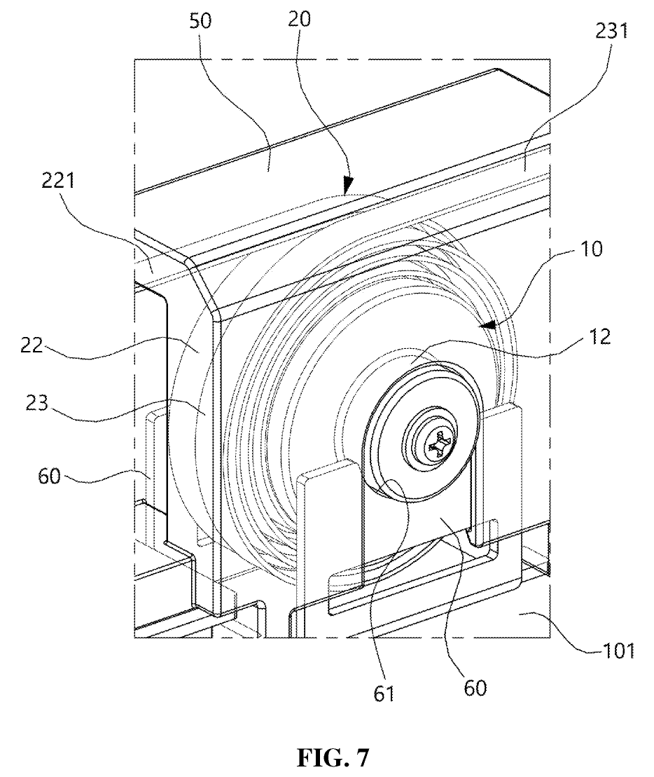

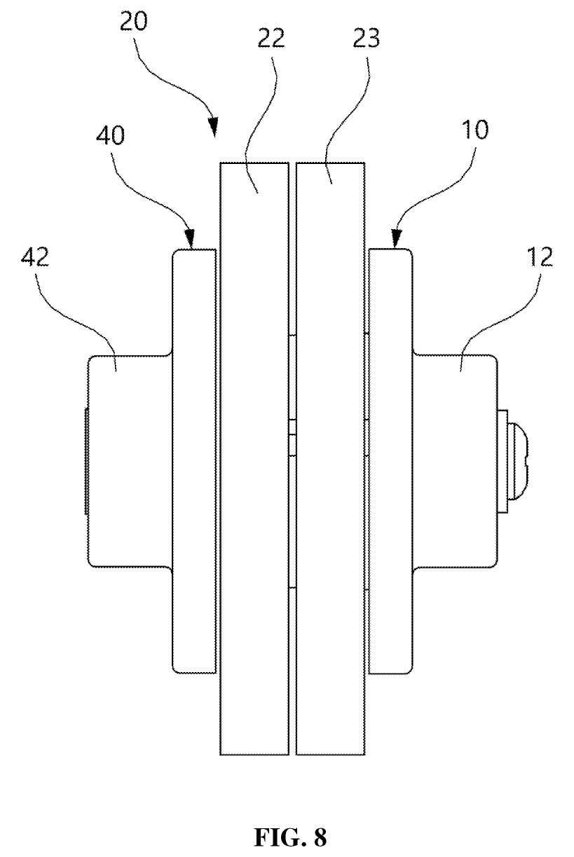

FIG. 7 is an enlarged view illustrating the seat moving apparatus for a vehicle according to the exemplary embodiment of the present disclosure. FIG. 8 is a front view illustrating the seat moving apparatus for a vehicle according to the exemplary embodiment of the present disclosure.

As illustrated in FIGS. 1, 7, and 8, the winding device 10 and the cover 40 may be mounted in a casing 50. The casing 50 may be mounted on the upper rail 101 by a coupling member, such as a bolt.

A seat rail 100 may include the upper rail 101 and the lower rail 102. The upper rail 101 may move along the lower rail 102 in the state in which the upper rail 101 is inserted into the lower rail 102.

The lower rail 102 may be mounted on a floor panel in a vehicle interior. The upper rail 101 may be connected to a seat (not illustrated). When a force is applied to the seat (not illustrated) in an unlocked state of a locking device 90, the upper rail 101 connected to the seat (not illustrated) may move along the lower rail 102. As a result, the seat (not illustrated) may be moved to a desired position.

When the locking device 90 operates in the state in which the seat (not illustrated) is moved to the desired position, locking protrusions 91 are inserted into locking holes 103 of the upper rail 101 and the lower rail 102, such that a locked state may be implemented. The locking device 90 may be implemented by various publicly-known configurations applied to the seat rail 100.

A first seating portion 12, which is provided on the other surface of the winding device 10, and a second seating portion 42, which is provided on the other surface of the cover 40, may be seated in a support groove 61 of a support frame 60 disposed in the casing 50 and provided on the upper rail 101. The support groove 61 may be configured in a semicircular shape that conforms to the first seating portion 12 and the second seating portion 42.

The end 221a of one side extension portion 221 may be exposed to the outside of the casing 50, pass through one side guide hole 711 of one side bracket 71 provided at one side of an upper portion of the upper rail 101, and be connected to one side of the lower rail 102. The end 221a of one side extension portion 221 may be connected to one side of the lower rail 102 by a connection frame 80.

The end 231a of the other side extension portion 231 may be exposed to the outside of the casing 50, pass through the other side guide hole 721 of the other side bracket 72 provided at the other side of the upper portion of the upper rail 101, and be connected to the other side of the lower rail 102. The end 231a of the other side extension portion 231 may be connected to the other side of the lower rail 102 by the connection frame 80.

A state in which secure tension of the tension member 20 is ensured may be maintained by an elastic force of the elastic member 30, a supporting force of one side bracket 71, and a supporting force of the other side bracket 72.

Next, an operation of the present disclosure will be described.

As illustrated in FIGS. 1 and 2, when a force, which is applied to a wire 93 in the locked state in which the locking protrusions 91 of the locking device 90 are inserted into the locking holes 103 of the upper rail 101 and the lower rail 102, is eliminated, a lever 92, which is elastically supported by a spring (not illustrated), may be rotated in an unlocking direction by an elastic force of the spring (not illustrated).

In conjunction with the above-mentioned operation, the locking protrusions 91 are separated from the locking holes 103 of the upper rail 101 and the lower rail 102, such that the unlocked state may be implemented.

When a force is applied to the seat (not illustrated) in the unlocked state, the seat (not illustrated) may be moved to a desired position.

When a force is applied to the seat (not illustrated), the upper rail 101 connected to the seat (not illustrated) may move along the lower rail 102 in a direction toward one side of the lower rail 102.

As the upper rail 101 moves in the direction toward one side of the lower rail 102, the winding device 10 may also move in the direction toward the one side of the lower rail 102 together with the upper rail 101.

The tension of one side wound portion 22, one side extension portion 221, the other side wound portion 23, and the other side extension portion 231 may be maintained by the elastic force of the elastic member 30, which is applied to the winding portion 11, when the winding device 10 moves in the direction toward the one side of the lower rail 102 together with the upper rail 101.

For example, when the winding device 10 moves in the direction toward the one side of the lower rail 102 together with the upper rail 101, one side extension portion 221 may move toward one side wound portion 22 and be wound around one side wound portion 22 in the state in which the tension is maintained, and in contrast, the other side wound portion 23 may be unwound toward the other side extension portion 231 in the state in which the tension is maintained.

The upper rail 101 may be stably slid along the lower rail 102, without swaying, by the tension of the tension member 20. As a result, the seat (not illustrated) connected to the upper rail 101 may stably move.

When the wire 93 is pulled in the state in which the upper rail 101 is moved to the desired position, the lever 92 may rotate in a locking direction.

As the lever 92 rotates in the locking direction, the locked state in which the locking protrusions 91 are inserted into the locking holes 103 of the upper rail 101 and the lower rail 102, in conjunction with the rotation of the lever 92, may be implemented. As a result, a state in which the upper rail 101 connected to the seat (not illustrated) cannot move may be implemented.

The above description is simply given for illustratively describing the technical spirit of the present disclosure, and those skilled in the art to which the present disclosure pertains will appreciate that various modifications, changes, and substitutions are possible without departing from the essential characteristics of the present disclosure. Accordingly, the embodiments disclosed in the present disclosure and the accompanying drawings are intended not to limit but to describe the technical spirit of the present disclosure, and the scope of the technical spirit of the present disclosure is not limited by the embodiments and the accompanying drawings. The protective scope of the present disclosure should be construed based on the following claims, and all the technical spirit in the equivalent scope thereto should be construed as falling within the scope of the present disclosure.

As described above, the exemplary embodiments have been described and illustrated in the drawings and the specification. The exemplary embodiments were chosen and described in order to explain certain principles of the disclosure and their practical application, to thereby enable others skilled in the art to make and utilize various exemplary embodiments of the present disclosure, as well as various alternatives and modifications thereof. As is evident from the foregoing description, certain aspects of the present disclosure are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the disclosure are deemed to be covered by the disclosure which is limited only by the claims which follow.

### DESCRIPTION OF REFERENCE NUMERALS

10: Winding device

11: Winding portion

113a: First through-hole

113b: Second through-hole

113c: Third through-hole

113d: Fourth through-hole

113e: Fifth through-hole

114: Contact portion

12: First seating portion

20: Tension member

21: Support portion

22: One side wound portion

221: One side extension portion

221a: End

23: The other side wound portion

231: The other side extension portion

231a: End

30: Elastic member

31: One side assembled portion

311: Hook portion

32: Catching portion

40: Cover

41: Protrusion portion

411: Fitting hole

42: Second seating portion

50: Casing

60: Support frame

61: Support groove

71: One side bracket

711: One side guide hole

72: The other side bracket

721: The other side guide hole

80: Connection frame

90: Locking device

91: Locking protrusion

92: Lever

93: Wire

100: Seat rail

101: Upper rail

102: Lower rail

103: Locking hole

What is claimed is:

1. A seat moving apparatus for a vehicle, the seat moving apparatus comprising:
a winding device configured to be disposed on an upper rail and having one surface, a winding portion extending from the one surface;
a tension member wound around the winding portion such that two opposite ends of the tension member, which are directed in opposite directions, are configured to be connected to two opposite sides of a lower rail, respectively, along a longitudinal direction of the lower rail; and
an elastic member disposed in the winding portion and configured to elastically support the winding device.

2. The seat moving apparatus of claim 1, wherein the tension member comprises:
a support portion positioned in the winding portion;
one-side wound portion extending from one end of the support portion and wound around a proximal portion of an outer-diameter portion of the winding portion, the proximal portion being positioned adjacent to the one surface of the winding device;
one-side extension portion extending from the one-side wound portion and having an end directed toward one side of the upper rail along a longitudinal direction of the upper rail;
another-side wound portion extending from another end of the support portion and wound around a distal portion of the outer-diameter portion of the winding portion, the distal portion being opposite to the proximal portion; and
another-side extension portion extending from the another-side wound portion and having an end directed toward another side of the upper rail along the longitudinal direction of the upper rail.

3. The seat moving apparatus of claim 2, wherein the winding portion comprises:
a first through-hole defined in the proximal portion of the outer-diameter portion at a first side thereof;
a second through-hole connected to the first through-hole and defined in the distal portion of the outer-diameter portion, the first through-hole and the second through-hole defining a stepped portion together;
a third through-hole defined in the proximal portion of the outer-diameter portion at a second side thereof;
a fourth through-hole connected to the third through-hole and defined in the distal portion of the outer-diameter portion, the third through-hole and the fourth through-hole defining a stepped portion together; and
a fifth through-hole defined in a portion of the outer-diameter portion between the first through-hole and the third through-hole.

4. The seat moving apparatus of claim 3, wherein the one-side wound portion penetrates the first through-hole and is wound inside the outer-diameter portion of the winding portion, and the another-side wound portion penetrates the fourth through-hole and is wound outside the outer-diameter portion of the winding portion.

5. The seat moving apparatus of claim 3,
wherein the elastic member includes one-side assembled portion,
wherein the one-side assembled portion penetrates the fifth through-hole and is wound around the outer-diameter portion of the winding portion, and a hook portion positioned at an end of the one-side assembled portion penetrates the fourth through-hole and is inserted into and caught by the winding portion.

6. The seat moving apparatus of claim 2,
wherein the distal portion defines an opening of the winding portion at a distal end thereof,
wherein a cover is coupled to the distal end of the winding portion to span the opening to retain the support portion and the elastic member in the winding portion.

7. The seat moving apparatus of claim 6,
wherein the cover comprises:
a protrusion portion extending from one surface of the cover in a direction toward the winding portion; and
a fitting hole defined in the protrusion portion.

8. The seat moving apparatus of claim 7,
wherein the elastic member includes a catching portion at another end of the elastic member,
wherein the catching portion is inserted into and caught by the fitting hole.

9. The seat moving apparatus of claim 2, wherein the elastic member is supported by a contact portion disposed inside the winding portion.

10. The seat moving apparatus of claim 9, wherein the contact portion surrounds at least a part of an outer side of the elastic member.

11. The seat moving apparatus of claim 6, wherein the winding device and the cover are disposed in a casing, and the casing is disposed on the upper rail.

12. The seat moving apparatus of claim 11, wherein a first seating portion, which is disposed on another surface of the winding device opposite to the one surface of the winding device, and a second seating portion, which is disposed on another surface of the cover opposite to the one surface of the cover, are seated in a support groove of a support frame disposed in the casing, the support frame being disposed on the upper rail.

13. The seat moving apparatus of claim 11, wherein the end of the one-side extension portion passes through one-side guide hole of one-side bracket disposed at one side of an upper portion of the upper rail and is connected to one side of the lower rail, and
wherein the end of the another-side extension portion passes through another-side guide hole of another-side bracket disposed at another side of the upper portion of the upper rail and is connected to another side of the lower rail.

14. The seat moving apparatus of claim 1, wherein the elastic member is a spiral spring.

15. The seat moving apparatus of claim 1, wherein the tension member is configured as a band-shaped wire capable of being wound around an outer-diameter portion of the winding portion.

16. The seat moving apparatus of claim 9, wherein the contact portion is a wall extending from the one surface of the winding device and surrounding at least a part of an outer side of the elastic member.

17. The seat moving apparatus of claim 16, wherein the support portion is wound around the wall in the winding portion, and the support portion and the elastic member are separated by the wall in the winding portion.

18. The seat moving apparatus of claim 3, wherein the stepped portion defined by the first through-hole and the second through-hole defines a first shoulder facing toward the one surface of the winding device, and the stepped portion defined by the third through-hole and the fourth through-hole defines a second shoulder facing away from the one surface of the winding device.
